(19) United States
(12) Patent Application Publication
(10) Pub. No.: US 2024/0372496 A1
(43) Pub. Date: Nov. 7, 2024

(54) NEXT GENERATION OF ELECTRONIC MAGNETIC GEARING

(71) Applicant: ePropelled Inc., Lowell, MA (US)

(72) Inventor: Nabeel SHIRAZEE, Cardiff (GB)

(73) Assignee: ePropelled Inc., Lowell, MA (US)

(21) Appl. No.: 18/259,372

(22) PCT Filed: Dec. 30, 2021
(86) PCT No.: PCT/GB2021/053442

§ 371 Date: Jun. 26, 2023

(30) Foreign Application Priority Data
Dec. 31, 2020 (GB) 2020844.3

(51) Int. Cl. H02P 25/18; B60L 15/20; G06F 8/65

(52) U.S. Cl. CPC H02P 25/18; G06F 8/65; B60L 15/20

(57) ABSTRACT

There is described a next-generation electronic magnetic gearing (eDTS) for an inverter drive for an electric vehicle including a primary firmware having an AI system to oversee all the operational aspects of the powertrain hardware and system firmware. The AI receives information from various sources such as shift maps, sensors data etc. and regularly alters and updates the algorithm and the data of the said maps and the hardware parameters based on usage and ageing to their respective firmware libraries, stored in an inverter drive's non-volatile memory or in the cloud. The stored data are accessed by the primary and system firmware and utilize the updated information to determine the most efficient winding configuration.

This invention relates to the next generation of electronic magnetic gearing with artificial intelligence.

The world is going electric and to make this change happen companies around the world are trying their utmost to come up with the best system solution that converts electrical energy into mechanical energy (or vice versa) most efficiently and cost-effectively. One such application is the electric machine operated either as a motor or a generator.

Electric machines have been designed and patented for over 100 years. The introduction of new materials has helped the development cause however in the past couple of decades new techniques such as described in patent U.S. Pat. No. 7,382,103B2 titled “Magnetic gearing of permanent magnet brushless motors”, have given a new innovative dimension to electric machines and drive designs.

### RELATED BACKGROUND ART

The Patent U.S. Pat. No. 7,382,103B2 describes how the winding in an electric machine can be reconfigured in series or in parallel or a combination of both to achieve high torque without drawing high current at low speeds and equally be effective at low torque at high speeds.

Several patents and publications disclose coil switching or winding reconfiguration in electric machines. However, none of the prior arts discloses any method/system to maximize all of the powertrain efficiencies before reconfiguring of the windings takes place. There are several aspects to be considered to achieve maximum powertrain efficiency before the windings can be reconfigured.

To achieve high efficiency of the powertrain, the timing of the reconfiguration must be optimized by considering various information such as shift maps data, sensors data, the health of the powertrain components/electronics etc., and processing the said information in real-time to select the most efficient winding configuration.

Thus, there is a need for an improved method to select an efficient winding configuration by the system firmware which has been updated regularly by the primary firmware comprising artificial intelligence (AI).

Moreover, the said method improves the powertrain efficiencies in multiple levels and predicts failure modes of the powertrain components in time for the user to take preventive action.

The invention is set out in the appended claims.

In an aspect of the present invention there is an electronic magnetic gearing (eDTS) communication system for an inverter drive comprising primary firmware, powertrain hardware and system firmware, further comprising an AI system to oversee operational aspects of the powertrain hardware and system firmware, wherein the AI system receives information from any one of the sources selected from the range; shift maps, sensor data maps, ageing data maps, pre fault data maps, and further wherein the AI system alters and updates the sources and hardware parameters to the respective firmware libraries. The libraries are stored in an inverter drive's non-volatile memory, whereby the system firmware accesses stored data and the most efficient winding configuration is determined based on the updated information. In some cases, the firmware libraries could be stored in the cloud.

In a second aspect of the present invention there is a method of operating an electronic magnetic gearing communication system (eDTS) for an inverter drive comprising primary firmware, powertrain hardware, system firmware, and an AI system, comprising the steps of (i) communicating information to the AI system from an inverter drive source, (ii) altering the algorithms and updating the sources and hardware parameters to the respective firmware libraries stored in the inverter drive's non-volatile memory, (iii) storing the updated sources, (iv) accessing, by the system firmware, the stored updated data and (v) utilizing the updated data to determine a most efficient winding configuration.

Preferably, the method of operating an electronic magnetic gearing communication system (eDTS) includes a step of altering and updating, by the primary firmware, the system firmware. Further preferably, there is a step of sending, by the primary firmware, information on the system to a cloud computing system or service, wherein the step of sending is carried out via wireless communication or hard-wired service centre. In addition, it is preferred that the method includes the steps of linking with a cloud computing system and of communicating with an AI capable supercomputer for high computational data analysis. The AI supercomputer is able to change fundamentals of the primary firmware.

A preferred method of operating an electronic magnetic gearing communication system (eDTS) further comprises the step of receiving information about the present condition of the powertrain components and their respective parameters, comparing the respective parameters with programmed reference values, updating the respective parameters, whereby obtained updated information is associated to predict the behaviour of a vehicle connected to the inverter drive and the information is communicated to a service agency via a notification for appropriate actions. In addition, it is preferred that the computational analysis with respect to the predictive calculation of the vehicle behaviour is performed by the system firmware and the results are communicated to the respective service centre and teams accordingly. Preferably if the AI system is not present in the vehicle, some of the predictive calculations are carried out by in-vehicle primary or system firmware.

The invention also comprises an electronic magnetic gearing (eDTS) communication system for an inverter drive where the function of the switch matrix connected to the inverter drive is to reconfigure the windings of the stator or the rotor.

The invention also further comprises an electronic magnetic gearing (eDTS) communication system for an inverter drive where the function of the switch matrix connected to the inverter drive is to reconfigure the windings of the electric machine in multiple combinations, and can also comprise an electronic magnetic gearing (eDTS) communication system for an inverter drive where the sensor data analysis unit scans and processes information received from all the sensors including but not limited to temperature sensors, hall effect sensors, strain gauges. The said data include the condition of the electric machine, switch matrix, inverter drive and the fixed ratio differential and their components. Further, the invention can comprise an electronic magnetic gearing (eDTS) communication system for an inverter drive where the ageing parameters analysis unit analyzes parametric values such as resistance and inductance of the windings, the flux density of the air gap in the electric machine, the temperature of the fixed ratio gearbox, inverter, motor, switch matrix, ageing of various components in power electronics by measuring parameter such as the changes in the current-carrying capabilities, the difference in the voltage and current waveforms and changes in back EMF. All the analytical results are compared with reference values for optimization of the system. The said source data is updated.

In a further example the invention comprises an electronic magnetic gearing (eDTS) communication system for an inverter drive in claim 13 where the AI learns about user behaviour and optimizes the powertrain operation accordingly and where Information learnt can be shared with all other vehicles. Furthermore, the invention comprises an electronic magnetic gearing (eDTS) communication system for an inverter drive where all the information that is shared with the supercomputer for data analysis is number crunched after which if a major firmware update release is required for which a human intervention may be needed or a lower level of a firmware update which does not require human intervention is sent immediately back to the cloud and into the bootloader of the vehicle.

The next-generation electronic magnetic gearing (eDTS) includes a primary firmware having an AI system to oversee all the operational aspects of the powertrain hardware and system firmware. The AI receives information from various sources such as shift maps, sensors data etc. and regularly updates the shift maps and the hardware parameters to their respective firmware libraries, stored in an inverter drive's non-volatile memory or in some cases stored in the cloud. The stored data is accessed by the primary firmware and utilizes the updated information to determine the most efficient winding configuration.

The primary firmware can also update the system firmware, if needed. The primary firmware may also send all the relevant information to the cloud computing system/services via wireless communication or a hard-wired service centre.

The cloud computing system is linked with a supercomputer for high computational data analysis or to a super computer with AI capabilities. One such function includes receiving information about the present condition of the powertrain components and their respective parameters which are regularly monitored and compared with programmed reference values and updated when necessary. The obtained information is associated to predict the behaviour of the vehicle and the information is communicated to the service agency via a notification for their appropriate actions. In one embodiment, some of the computational analysis with respect to the predictive calculation of the vehicle behaviour is performed by the system firmware and the results are communicated to the respective service centre and teams accordingly.

In another embodiment, where the AI is not present in the vehicle, some of the predictive calculations may be carried out by in-vehicle primary firmware and the remaining complex calculations by the cloud AI supercomputer.

Embodiments of the present invention will now be described by way of example. Some embodiments may be practiced with additional components or steps and/or without all of the components or steps illustrated.

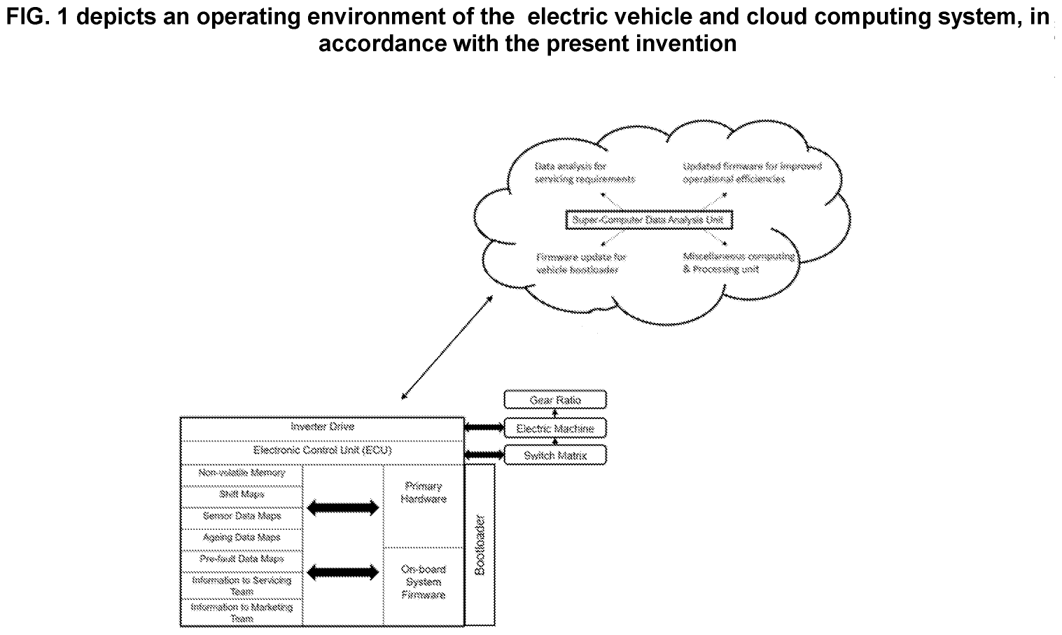

FIG. 1 is a diagrammatic representation of the operating environment of the vehicle and cloud computing system or services, in accordance with the present invention;

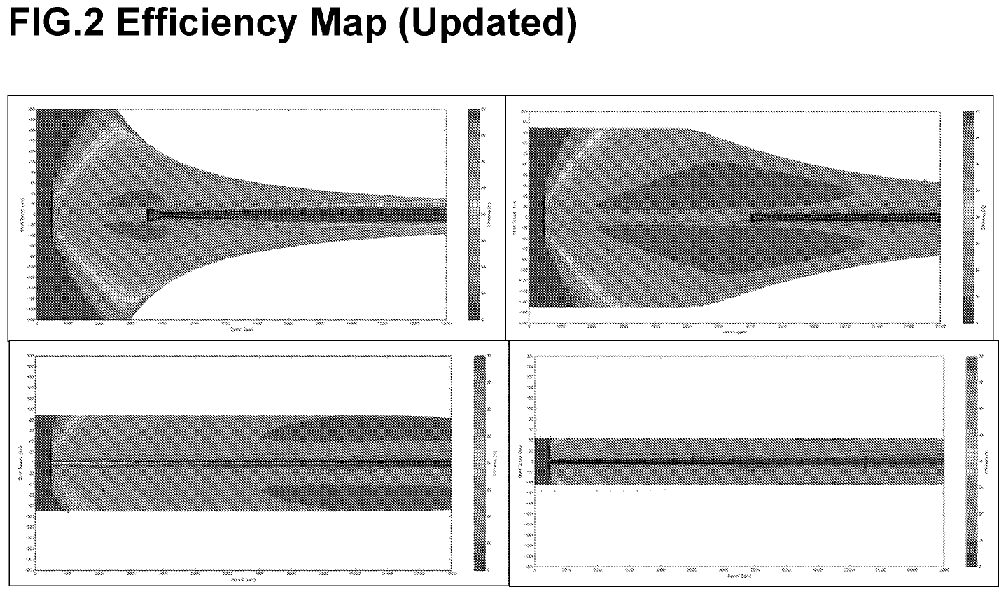

FIG. 2 is a graphical view illustrating the efficiency of the electric machine with varying configurations;

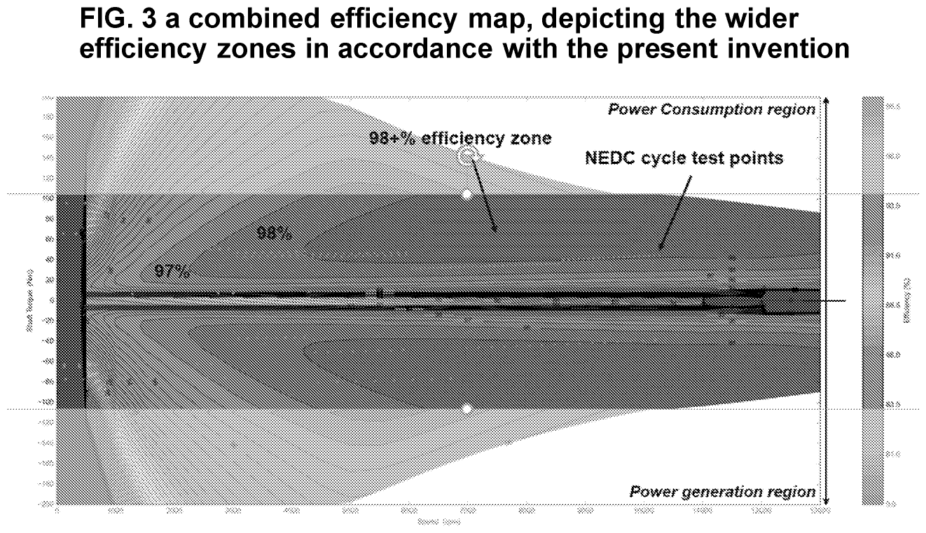

FIG. 3 is a graphical view of a combined efficiency map of an electric machine;

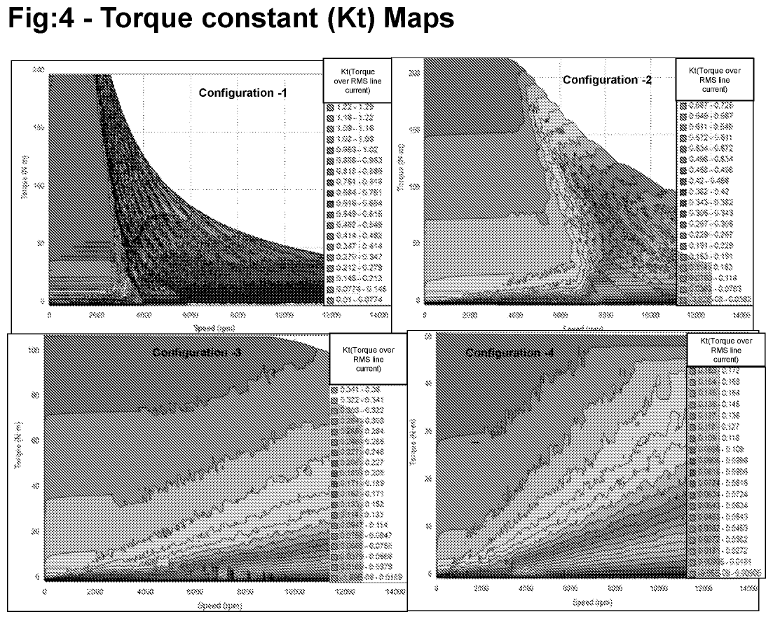

FIG. 4 is a graphical view illustrating the Torque Constant (Kt) maps of the electric machine with varying configurations;

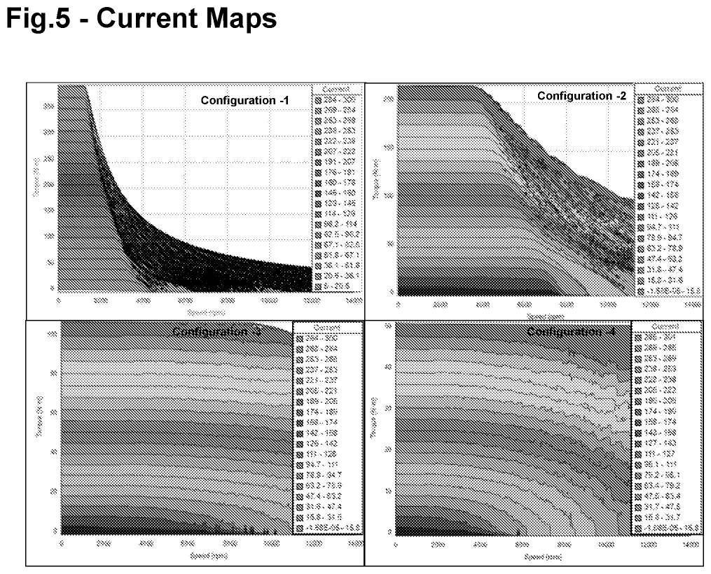

FIG. 5 is a graphical view illustrating the current maps of the electric machine with varying configurations;

The next-generation electronic magnetic gearing, which is now called eDTS (efficient Dynamic Torque Switching) primarily comprises a primary firmware incorporated with AI, hardware and onboard system firmware.

The powertrain hardware comprises an inverter drive, wherein several libraries are present in its non-volatile memory. In some cases, the libraries can also be stored in the cloud to be accessed by other vehicles. The inverter drive is also known as a motor controller for electric machines. The switch matrix is connected to the inverter drive and the electronic control unit, on one side and the electric machine on the other side. The function of the switch matrix is to reconfigure the windings of the electric machine. The default setting is the parallel configuration from which multiple combinations of configurations are achieved.

It is to be noted that, the said switch matrix can also be used in the rotor or stator of an electric machine.

A fixed gear ratio such as 10:1 is used to reduce the size of the electric machine which runs faster with higher gear ratios. In some applications, the fixed-gear ratio may not be required.

The inverter drive also has several libraries in its non-volatile memory unit/section which can be accessed by the primary firmware and the system firmware to regularly analyze or to update the information such as shift maps, sensors data, ageing of the powertrain components etc.

The shift maps are maps including but not limited to the current map, voltage map, Torque constant (Kt) map, winding loss map, Iron loss map, output power map etc. to determine the best efficient or operational point of the vehicle demanded by the user. Accordingly, the winding configuration is selected.

The sensor data analysis unit scans and processes information received from all the sensors including but not limited to temperature sensors, hall effect sensors, strain gauges etc. These data include the condition of the electric machine, switch matrix, inverter drive and the fixed ratio differential and their components.

The ageing parameters analysis unit analyzes parametric values such as resistance and inductance of the windings, the flux density of the air gap in the electric machine, the temperature of the fixed ratio gearbox, inverter, motor, switch matrix, ageing of various components in power electronics by measuring the changes in the current-carrying capabilities, the difference in the voltage and current waveforms and changes in back EMF. All the analytical results are compared with reference values for optimization of the system and winding configuration. The said source data is updated and configured.

The pre-fault analysis unit regularly monitors the present condition of the components of the powertrain and predicts the health of the vehicle based on real-time data and transmits the same to the service team for further evaluation.

The said feature can be accessed in the vehicle or from the cloud depending on the model/make of the vehicle.

In addition, information to the servicing team and information to the marketing team is also present which gather the relevant analyzed information for the predictive study of the vehicle or the marketing team for further analysis.

It is to be understood that these modules can also independently communicate to the service centre or the respective company's team to share the relevant information.

In addition, the said information is stored in the cloud computing system for any team such as marketing, belonging to the company to access and understand the vital parameters and useful data, after having sensitive GDPR information removed by an AI algorithm or manually by an operator.

The primary firmware with AI continuously monitors when the next winding configuration is more efficient during the drive cycle based on the demand by the user of the vehicle. The artificial intelligence software decides in Pico seconds the best point of operation in each of the maps and selects the correct winding configuration for the desired vehicle speed and torque extremely fast.

In addition, the AI learns about user behaviour and optimizes the powertrain operation accordingly.

The onboard system firmware is another vital part of the said system, which monitors and updates information in the bootloader and shift maps. The primary firmware updates the bootloader at regular intervals. The primary firmware also receives information from the cloud computing system or the service centre. It validates the updated firmware and then transmits it to the bootloader and into the main processor at a predetermined time.

Apart from the said modules, the cloud computing system or services includes a supercomputer with or without AI capabilities. A supercomputer is the fastest high-performance system preferred for high-speed computations. In the present invention, all the information that is shared with the supercomputer for data analysis is number crunched after which if a major firmware update release is required for which a human intervention may be needed or a lower level of a firmware update which does not require human intervention is sent immediately back to the cloud and into the bootloader of the vehicle.

The parameters learnt from the machine learning from a vehicle (A) can be uploaded into the cloud database and verified. After verification, it can be automatically downloaded to another vehicle (B) connected with cloud connectivity or at the service station. In a vehicle (B), the new firmware arrives at the bootloader and is then downloaded into the vehicle main ECU/processor for further verification and execution.

Miscellaneous processing and computing could be carried out by computers other than the supercomputer.

FIG. 2 illustrates efficiency maps for various configurations. It clearly depicts that the maximum efficiency zone is shifting with each configuration compared to the previous configurations. When all the maps are combined, the maximum efficiency zone expands across the speed-torque range, which is shown in FIG. 3

Hence, reconfiguring the windings does provide the advantage of high efficiency through a broader speed-torque range and the timing of the reconfiguration is determined by the system firmware.

FIG. 4 shows the Torque Constant (Kt) maps for the various configurations. It is an important, as it shows the map of magnetic saturation within the electric machine. The configuration with the highest Kt value should be selected. Kt maps should be taken into account, when determining the reconfiguration.

FIG. 5 shows current maps for various configurations. This is an important map to consider as the selection of the configuration should be based on the temperature of the powertrain components e.g.: If the user is demanding 50 Nm torque at 4000 rpm, and if the powertrain has reached its temperature limit of 180° C. then one would select configuration-2, as this configuration takes the least amount of current to achieve the speed even though from the efficiency perspective, it may not be the most efficient configuration.

The method to select an efficient winding configuration in real-time involves receiving information from shift maps, sensors data, aged parameters of the powertrain components and user input such as speed and torque demand, identifying the efficient winding configuration based on the parametric inputs and instructing the switch matrix to select the identified winding configuration during the drive cycle.

In certain scenarios, the powertrain components such as the electric machine parameters may change due to ageing. By way of example, the resistance and inductance of the winding may change as the windings become older and the magnetic field weakens. This will impact the way the firmware operates the electric machine if it was still operating with the original set parameters. To recover the efficiency, the primary firmware measures and alters the resistance and the inductance of new values to maximize the efficiency of the powertrain. The magnetic field in the airgap is also measured to optimize the operation of the electric machine.

During such operations, the firmware adapts and changes the base frequency to run the powertrain at its optimal level. For e.g.: the base frequency of the inverter drive maybe 8 kHz. This may be sufficient at lower speeds of operation of the electric machine. However, to extract maximum performance from the electric machine, the base frequency may change on the fly to 16 kHz, if needed. We call this base frequency hopping.

In another embodiment, there may be another section that monitors and updates the age/functioning of parts of the powertrain, periodically updates the parameters without the artificial intelligence. The said example does not limit the way the firmware operates.

1. An electronic magnetic gearing (eDTS) communication system for an inverter drive for an electric machine, the system comprising primary firmware, powertrain hardware and system firmware, further comprising an AI system to oversee operational aspects of the powertrain hardware and system firmware, wherein the AI system receives information from any one of the sources selected from the range; shift maps, sensor data maps, ageing data maps, pre-fault data maps, and further wherein the AI system alters and updates the sources and hardware parameters to the respective firmware libraries, stored in an inverter drive's non-volatile memory, whereby the system firmware accesses stored data and the most efficient winding configuration is determined based on the updated information, where a sensor data analysis unit scans and processes information received from all of a plurality of sensors including but not limited to temperature sensors, hall effect sensors, strain gauges, the said stored data including the condition of the electric machine, switch matrix, inverter drive and the fixed ratio differential and their components, wherein the ageing parameters analysis unit analyses parametric values such as resistance and inductance of the windings, the flux density of an air gap in the electric machine, the temperature of a fixed ratio gearbox connected to the electric machine, inverter, motor, switch matrix, ageing of various components in power electronics by measuring the changes in the current-carrying capabilities, the difference in the voltage and current waveforms and changes in back EMF, all of the analytical results are compared with reference values for optimization of the system.

2. An electronic magnetic gearing (eDTS) communication system for an inverter drive as claimed in claim 1, further comprising a cloud computing system where there is two way or multiple way communication between the cloud and the vehicle/s.

3.-13. (canceled)

14. An electronic magnetic gearing (eDTS) communication system for an inverter drive as claimed in claim 1, where the AI learns about user behaviour and optimizes the powertrain operation accordingly and where Information learnt can be shared with all vehicles.

15. An electronic magnetic gearing (eDTS) communication system for an inverter drive as claimed in claim 1, where all the information that is shared with the supercomputer for data analysis is number crunched after which if a major firmware update release is required for which a human intervention may be needed or a lower level of a firmware update which does not require human intervention is sent immediately back to the cloud and into the bootloader of the vehicle.
